(19) United States
(12) Patent Application Publication
(10) Pub. No.: US 2010/0079633 A1
(43) Pub. Date: Apr. 1, 2010

(54) IMAGE SENSOR AND MANUFACTURING METHOD OF IMAGE SENSOR

(76) Inventor: JONG MAN KIM, Gyeonggi-do (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/563,282

(22) Filed: Sep. 21, 2009

(30) Foreign Application Priority Data
Sep. 30, 2008 (KR) 10-2008-0096105
Sep. 30, 2008 (KR) 10-2008-0096110

(51) Int. Cl. H04N 5/335

(52) U.S. Cl. 348/294; 348/E05.091

(57) ABSTRACT

Disclosed are an image sensor and a method for manufacturing the same. The image sensor can include a readout circuitry formed on a first substrate; an interlayer dielectric layer including at least one metal and contact plug electrically connected to the readout circuitry; and an image sensing device formed on a second substrate, bonded to the interlayer dielectric layer, and provided with a first conductive type conduction layer and a second conductive type conduction layer. The image sensor further includes a plurality of uppermost contact plugs arranged in a three-dimensional matrix configuration at an uppermost metal area, each uppermost contact plug extending from an uppermost metal of the at least one metal to an inner portion of the first conductive type conduction layer.

### CROSS-REFERENCE TO RELATED APPLICATIONS

This application claims the benefit under 35 U.S.C. §119 of Korean Patent Application Nos. 10-2008-0096105 and 10-2008-0096110, both filed Sep. 30, 2008, which are hereby incorporated by reference in their entirety.

### BACKGROUND

In general, an image sensor is a semiconductor device for converting optical images into electric signals, and is classified into a charge coupled device (CCD) image sensor and a complementary metal oxide semiconductor (CMOS) image sensor (CIS).

According to the related art, a photodiode (PD) is formed on a substrate by implanting ions into the substrate. However, as the size of the PD is gradually decreased such that the number of pixels is increased without the increase of a chip size, the size of a light receiving part is reduced so that an image quality may be degraded.

In addition, there has been suggested a method for increasing the electron generation rate by increasing capacitance of the PD. However, expanding a depletion region of the PD to increase the capacitance is limited, and the light aperture ratio may be lowered due to the structure formed in the back end process of the PD.

As an alternative method to overcome the above problems, there has been suggested a method of forming the PD by depositing amorphous silicon (Si). In addition, there has been suggested a structure, in which a readout circuitry is formed on a Si-substrate (main substrate) through a wafer-to-wafer bonding scheme, and the PD is formed on another substrate (donor substrate) provided on the readout circuitry (hereinafter, referred to as “PD-up CIS” or “three dimensional (3-D) image sensor”).

Such a structure can be obtained by bonding the donor substrate with the main substrate after sequentially forming a p+ area, an n− area, and an n+ area on a PD region of the donor substrate.

According to the above structure, the light aperture ratio can be improved and the depletion region (p-area) of the PD can be expanded. Thus, higher capacitance can be achieved, so that the high electron generation rate can be obtained.

However, defects may occur in the process of bonding the donor substrate with the main substrate. For instance, contact defects may occur in a contact plug, which connects the PD of the donor substrate with metal, or the insulating property may be degraded between components of the Si-substrate.

In these cases, current generated from the PD of the donor substrate may not be easily transferred to the readout circuitry of the main substrate due to high resistance of about 10⁵Ω to 10⁸Ω, so the operational reliability of the image sensor may be degraded.

### BRIEF SUMMARY

Embodiments of the present invention provide a vertical type three-dimensional image sensor and a method for manufacturing the same, in which a donor substrate is bonded to a main substrate while ensuring stable electric connection therebetween.

An image sensor according to an embodiment includes a readout circuitry formed on a first substrate; an interlayer dielectric layer including at least one metal and contact plug electrically connected to the readout circuitry; an image sensing device formed on a second substrate, bonded to the interlayer dielectric layer, and provided with a first conductive type conduction layer and a second conductive type conduction layer; and a plurality of uppermost contact plugs arranged in a three-dimensional matrix configuration at an uppermost metal area and extending from an uppermost metal to an inner portion of the first conductive type conduction layer.

A method for forming an image sensor according to an embodiment includes forming a readout circuitry on a first substrate; forming an interlayer dielectric layer including at least one metal and contact plug electrically connected to the readout circuitry; bonding a second substrate having an image sensing device including a first conductive type conduction layer and a second conductive type conduction layer to the interlayer dielectric layer such that the first conductive type conduction layer faces the interlayer dielectric layer; and forming a plurality of uppermost contact plugs extending from an uppermost metal of the interlayer dielectric layer to an inner portion of the first conductive type conduction layer, wherein the uppermost contact plugs arranged in a three-dimensional matrix configuration at an uppermost metal area.

### BRIEF DESCRIPTION OF THE DRAWINGS

FIG. 1 is a cross-sectional view showing the structure of an image sensor according to a first embodiment;

FIGS. 2-12 are cross-sectional views illustrating a method of forming an image sensor according to the first embodiment;

FIG. 13 is a plan view showing the structure of contact plugs with insulating layers thereon of an image sensor according to an embodiment;

FIG. 14 is a plan view showing the structure of contact plugs with insulating layers thereon of an image sensor according to another embodiment;

FIG. 15 is a cross-sectional view showing the structure of an image sensor according to a second embodiment; and

FIG. 16 is a cross-sectional view showing the structure of an image sensor according to a third embodiment.

### DETAILED DESCRIPTION

Hereinafter, an image sensor and a method for manufacturing the same according to the embodiments will be described in detail with reference to accompanying drawings.

Detailed description about well-known functions or configurations may make the subject matter of the disclosure unclear. Accordingly, hereinafter, description will be made regarding only essential components directly related to the technical scope of the disclosure.

In the description of embodiments, it will be understood that when a layer (or film) is referred to as being ‘on’ another layer or substrate, it can be directly on another layer or substrate, or intervening layers may also be present. Further, it will be understood that when a layer is referred to as being ‘under’ another layer, it can be directly under another layer, or one or more intervening layers may also be present. In addition, it will also be understood that when a layer is referred to as being ‘between’ two layers, it can be the only layer between the two layers, or one or more intervening layers may also be present.

Although embodiments will be described with reference to a CMOS image sensor, the embodiments are not limited to the CMOS image sensor, but are applicable for various image sensors having photodiodes.

The doping symbols shown in Table 1 will be used in the following description.

TABLE 1

| | Doping symbols | | | | |
|---|---|---|---|---|---|
| | n++/p++ | n+/p+ | n0/p0 | n−/p− | n−−/p−− |
| Doping level L (number/cm³) | L > 1¹⁹ | 1¹⁹ ≧ L > 1¹⁸ | L = 1¹⁸ | 1¹⁸ > L ≧ 1¹⁷ | L < 1¹⁷ |

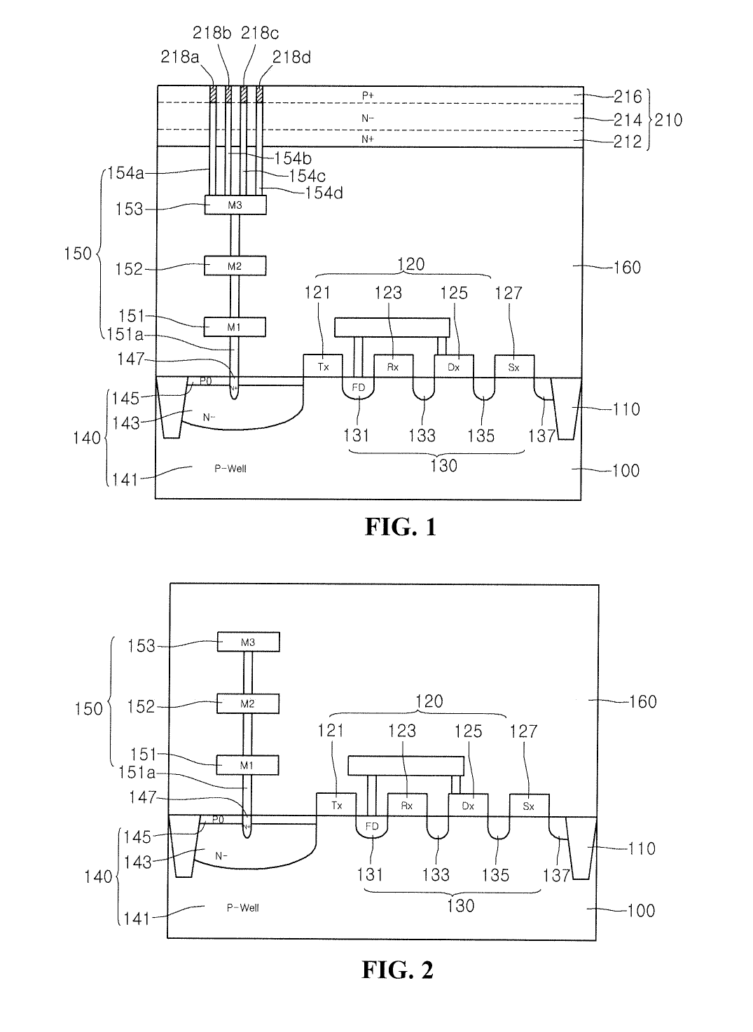

Referring to FIG. 1, an image sensor according to a first embodiment includes a readout circuitry 120 formed on a first substrate 100, an electric junction area 140 formed on the first substrate 100 and electrically connected to the readout circuitry 120, an interconnection 150 electrically connected to the electric junction area 140, and an image sensing device 210 formed on the interconnection 150.

The image sensing device 210 may include a photodiode, but embodiments are not limited thereto. For example, the image sensing device 210 may include a photo gate or a combination of the photodiode and the photo gate. Although the first embodiment will be described in that the photodiode 210 is formed on the crystalline semiconductor layer, the first embodiment is not limited thereto. For instance, the photodiode 210 can be formed on an amorphous semiconductor layer.

Reference numbers shown in FIG. 1 will be further explained in the description of the method for manufacturing the image sensor. Hereinafter, a method for manufacturing an image sensor according to the first embodiment will be described with reference to FIGS. 2 to 12.

Referring to FIG. 2, a first substrate (main substrate) 100 formed with readout circuitry 120 is prepared. For instance, an isolation layer 110 is formed on a second conductive type first substrate 100 to define an active area, and the readout circuitry 120 including transistors is formed on the active area. The readout circuitry 120 may include a transfer transistor Tx 121, a reset transistor Rx 123, a drive transistor Dx 125 and a select transistor Sx 127. Then, an ion implantation area 130 including a floating diffusion area 131 and source/drain areas 133, 135 and 137 for the transistors can be formed. In addition, according to the first embodiment, a noise removal circuitry (not shown) can be formed to improve sensitivity.

The step of forming the readout circuit 120 on the first substrate 100 may include the steps of forming the electric junction area 140 on the first substrate 100 and forming a first conductive type connection region 147, which is connected to the interconnection 150, on the electric junction area 140.

For instance, the electric junction area 140 may include a PN junction, but embodiments are not limited thereto. The electric junction area 140 may include a first conductive type ion implantation area 143 formed on a second conductive type well 141 or second conductive type epitaxial layer, and a second conductive type ion implantation area 145 formed on the first conductive type ion implantation area 143. For example, as shown in FIG. 2, the PN junction area 140 may include a P0−/N−/P− junction, but the embodiment is not limited thereto. In addition, the first substrate 100 may be a second conductive type substrate, but the embodiment is not limited thereto.

According to the first embodiment, the device is designed such that potential difference may exist between source/drains areas of the transfer transistor Tx such that photo charges can be fully dumped. In this case, the photo charges generated from the photodiode are dumped into the floating diffusion area, so that sensitivity of the output image can be maximized.

That is, according to the first embodiment, the electric junction area 140 is formed on the first substrate 100 having the readout circuitry 120 as shown in FIG. 2, so that potential difference is generated between the source/drain areas at sides of the transfer transistor Tx, thereby allowing the photo charges to be fully dumped.

Hereinafter, the photo charge dumping structure according to the first embodiment will be described in detail.

Unlike a node of the floating diffusion region FD 131, which may be an N+ junction, according to the first embodiment, voltage may not be fully applied to the P/N/P junction serving as the electric junction area 140 and may be pinched-off at a predetermined voltage. This voltage is called a pinning voltage and depends on doping concentrations of the P0 region 145 and the N− region 143.

In detail, electrons generated from the photodiode 210 are moved to the PNP junction 140, and then transferred to the node of the floating diffusion region FD 131 when the transfer transistor Tx 121 is turned on. The electrons are converted into a voltage.

Since a maximum voltage value of the P0/N−/P− junction 140 may become a pinning voltage, and a maximum voltage value of the node of the floating diffusion region FD 131 may become Vdd minus the threshold voltage Vth of Rx 123, electrons generated from the photodiode 210 formed on an upper portion of a chip may be fully dumped to the node of the floating diffusion region FD 131. This may be done without charge sharing due to the potential difference between the two sides of the transfer transistor Tx 121.

That is, according to the first embodiment, a P0/N−/P-well junction, not an N+/P-well junction, may be formed on the silicon substrate serving as the first substrate 100. Since a positive (+) voltage is applied to the N− area 143 of the P0/N−/P-well junction and a ground voltage is applied to the P0 area 145 and the P-well 141 during the 4-Tr APS (active pixel sensor) reset operation, a pinch-off may be generated to the P0/N−/P-well double junction at a predetermined voltage or more. This may be similar to a bipolar junction transistor (BJT) structure and called a pinning voltage. Thus, the potential difference may be generated between source and drain areas at the two sides of the transfer transistor Tx 121, thereby inhibiting the charge sharing during the on/off operations of transfer transistor Tx 121.

Therefore, unlike the related art where the photodiode may be simply connected to the N+ junction, problems such as saturation reduction and sensitivity reduction may be avoided.

Then, the first conductive type connection region 147 is formed between the photodiode 210 and the readout circuitry 120. This may provide a relatively swift movement path of the photo charges, so that a dark current source can be minimized, and saturation reduction and sensitivity reduction can be minimized or prevented.

To this end, according to the first embodiment, the first conductive type connection region 147 for ohmic contact can be formed on a surface of the P0/N−/P− junction 140. For example, the N+ region 147 may contact the N− region 143 by passing through the P0 region 145.

In order to inhibit the first conductive type connection region 147 from becoming a leakage source, a width of the first conductive type connection region 147 may be minimized. To this end, a plug implant may be performed after a contact hole for a first metal contact 151a is etched, but the embodiment is not limited thereto. According to certain embodiments, other processes may be performed. For instance, an ion implantation pattern (not shown) can be formed exposing the region into which the first conductive type connection region 147 is to be formed, and the first conductive type connection region 147 can be formed by using the ion implantation pattern as an ion implantation mask.

That is, according to the first embodiment, only a contact forming portion is locally doped with N+ impurities to facilitate the formation of the ohmic contact while minimizing a dark signal. According to the related art, the entire surface of the transfer transistor source is doped with N+ impurities, so the dark signal may be increased due to the Si surface dangling bond.

Then, an interconnection 150 and interlayer dielectric layer 160 can be formed on the first substrate 100. The interconnection 150 may include the first metal contact 151a, a first metal 151, a second metal 152, a third metal 153, and contact plugs electrically connecting the metals to each other, but embodiments are not limited thereto.

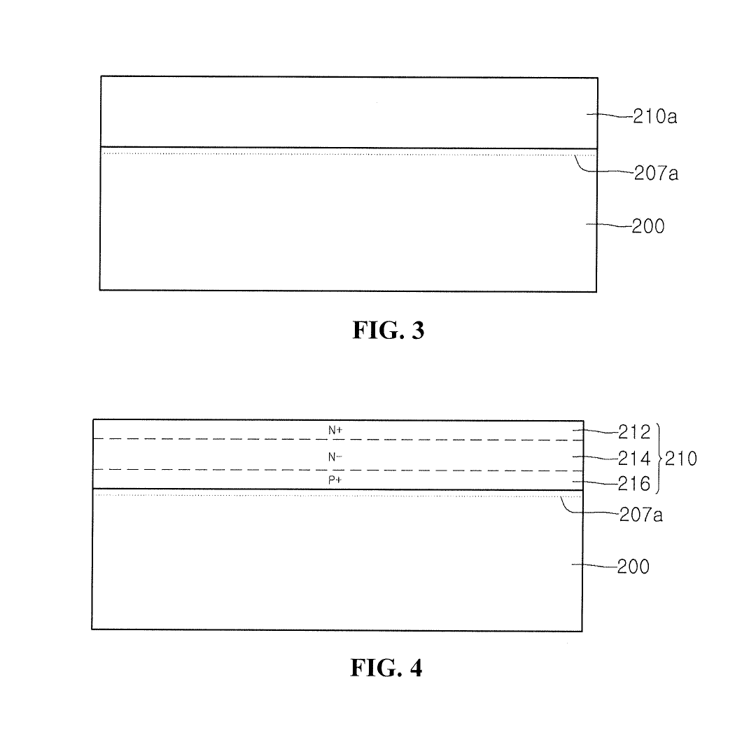

FIG. 3 is a cross-sectional view showing a donor second substrate of an embodiment.

As shown in FIG. 3, a crystalline semiconductor layer 210a is formed on the second substrate (donor substrate) 200. According to the first embodiment, the photodiode 210 is formed on the crystalline semiconductor layer 210a. Therefore, a three-dimensional image sensor equipped with an image sensing device positioned over the readout circuitry can be provided, so that the fill factor can be improved. In addition, since the image sensing device is formed in the crystalline semiconductor layer, the defect in the image sensing device can be inhibited.

For instance, the crystalline semiconductor layer 210a may be formed on the second substrate 200 through epitaxial growth. Then, hydrogen ions are implanted onto the boundary between the second substrate 200 and the crystalline semiconductor layer 210a, thereby forming a hydrogen ion implantation layer 207a. In another embodiment, the implantation of hydrogen ions may be performed after an ion implantation for forming the photodiode 210.

FIG. 4 is a cross-sectional view showing the structure of a photodiode on the second substrate according to an embodiment.

Referring to FIG. 4, a photodiode 210 can be formed on the crystalline semiconductor layer 210a through ion implantation. For instance, a second conductive type conduction layer 216 (later serving as the ground) may be formed at a lower portion of the crystalline semiconductor layer 210a near its boundary with the second substrate 200. For example, a first blanket-ion implantation is performed over the entire surface of the second substrate 200 without a mask, thereby forming a high-concentration second conductive type conduction layer 216 at the lower portion of the crystalline semiconductor layer 210a. According to this embodiment, the second conductive type is P-type and the first conductive type is N-type.

Then, a first conductive type conduction layer 214 (later serving as a light receiving portion) is formed on the second conductive type conduction layer 216. For instance, a blanket-ion implantation is performed over the entire surface of the second substrate 200 without a mask, thereby forming the first conductive type conduction layer 214.

After that, according to the first embodiment, a high concentration first conductive type conduction layer 212 may be formed on the first conductive type conduction layer 214. For example, a blanket-ion implantation is performed over the entire surface of the second substrate 200 without a mask, thereby forming the high concentration first conductive type conduction layer 212, which may contribute to the ohmic contact.

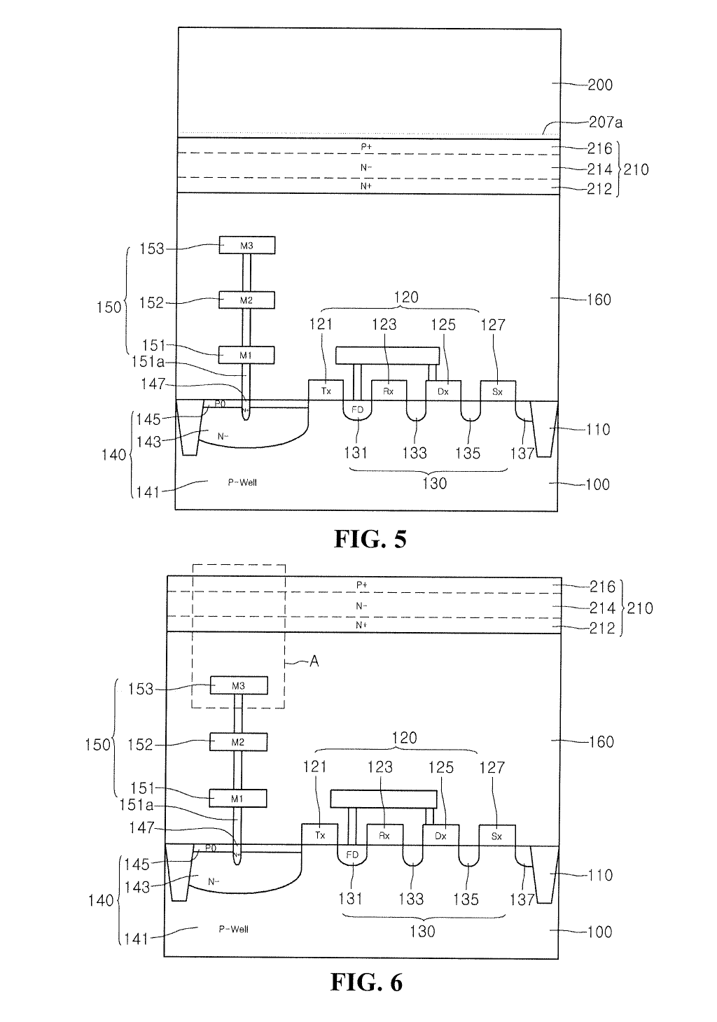

FIG. 5 is a cross-sectional view, according to an embodiment, showing the structure of the image sensor after the first substrate 100 has been bonded to the second substrate 200.

As shown in FIG. 5, the second substrate 200 is turned over and bonded to the first substrate 100 such that the photodiode 210 may contact the interlayer dielectric layer 160. Before the first substrate 100 is bonded to the second substrate 200, a surface energy of the bonding surfaces can be increased through activation of plasma. In order to enhance the bonding strength, an insulating layer or a metal layer can be disposed on a bonding interface.

Then, referring to FIG. 6, the hydrogen ion implantation layer 207a may be changed into a hydrogen gas layer (not shown) by performing heat treatment to the second substrate 200. Then, on the basis of the hydrogen gas layer, the second substrate 200 is partially removed by using a blade and the photodiode 210 remains such that the photodiode 210 can be exposed.

Trenches (not shown) are formed to divide the photodiode 210 corresponding to pixels. These trenches are filled with an insulating layer to form a PTI (pixel trench isolation).

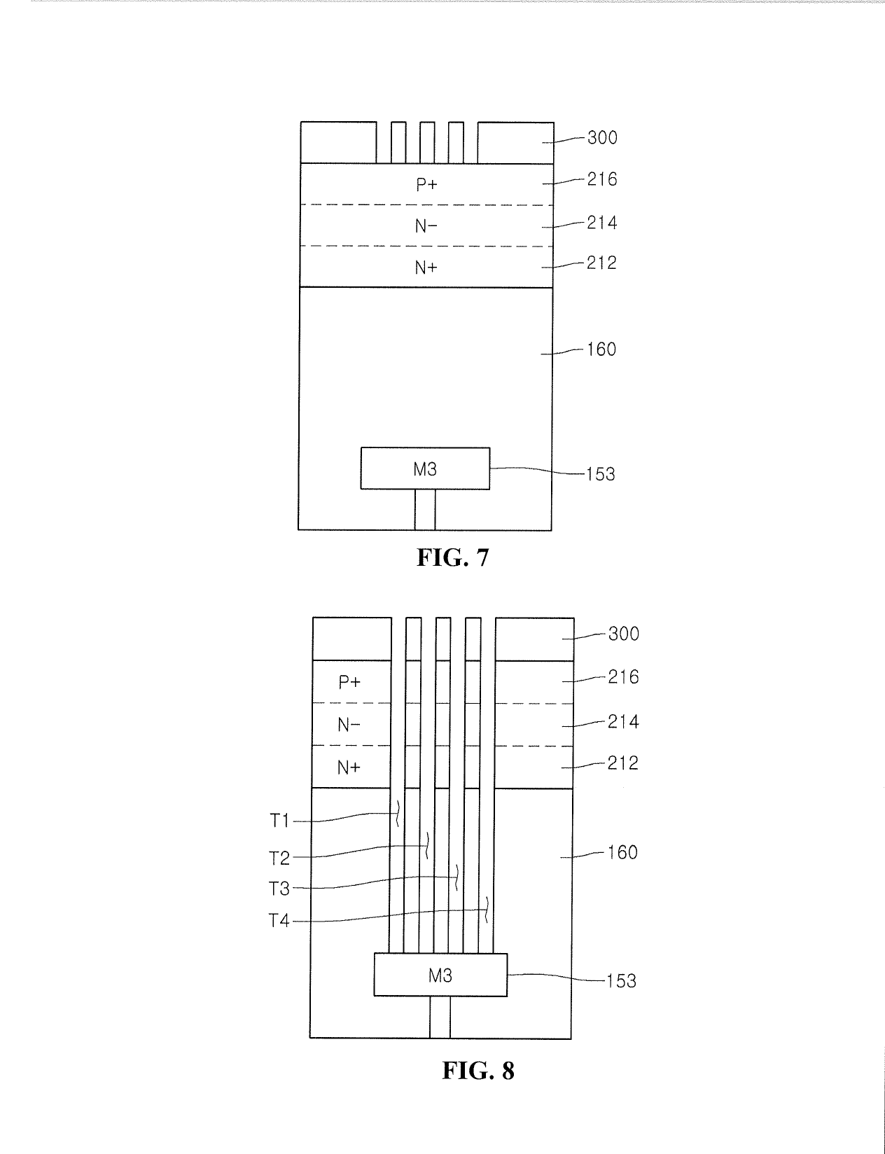

Hereinafter, the method for electrically connecting the third metal 153, which is the uppermost metal in this embodiment, to the photodiode 210 will be described with reference to FIGS. 7 to 13.

FIGS. 7 to 13 are enlarged views of the “A” region shown in FIG. 6.

FIG. 7 is a cross-sectional view showing the structure of the image sensor after a first photoresist pattern has been formed, and FIG. 8 is a cross-sectional view showing the structure of the image sensor after trenches have been formed.

In particular, referring to FIGS. 7 and 8, after the first substrate 100 has been bonded to the second substrate 200 and the photodiode is exposed, a first photoresist pattern 300 is formed on the second conductive type conduction layer 216 to expose regions corresponding to several portions of the third metal 153. Then, an etching process is performed to form a first trench T1, a second trench T2, a third trench T3 and a fourth trench T4, as shown in FIG. 8.

The first to fourth trenches T1 to T4 may extend from the top surface of the second conductive type conduction layer 216 to the top surface of the third metal 153. After forming the trenches, the first photoresist pattern 300 is removed. It should be noted that while a single row with four trenches are formed in this embodiment, embodiments are not limited to four trenches or a single row of trenches.

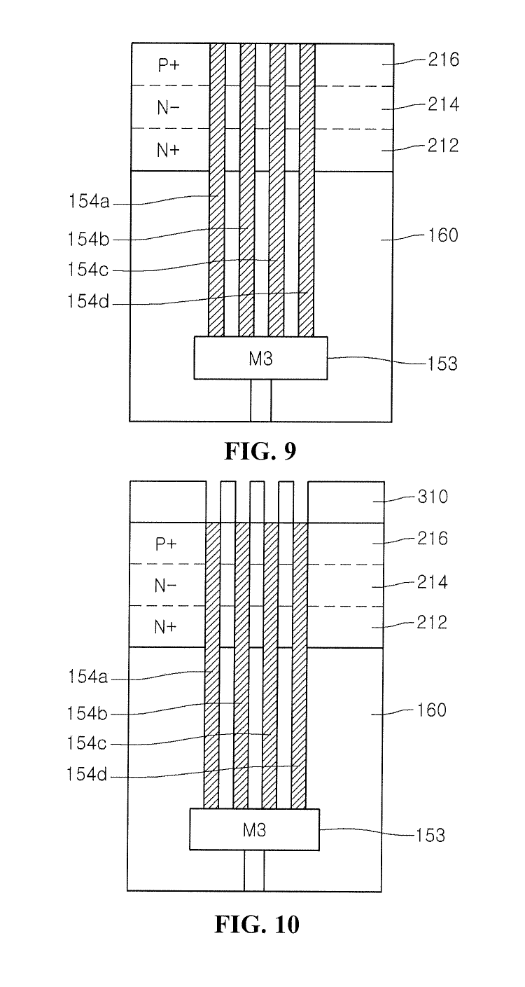

Referring to FIG. 9, a metal layer is deposited on the second conductive type conduction layer 216 such that the first to fourth trenches T1 to T4 are filled with the metal layer, and a planarization process is performed with respect to the metal layer, thereby forming a first contact plug 154a, a second contact plug 154b, a third contact plug 154c, and a fourth contact plug 154d electrically communicated with the third metal 153. In one embodiment, the metal layer can include tungsten.

The first to fourth contact plugs 154a to 154d may transfer electrons generated from the photodiode 210 to the readout circuitry 120 of the first substrate 100. Thus, the first to fourth contact plugs 154a to 154d must be electrically isolated from the second conductive type conduction layer 216.

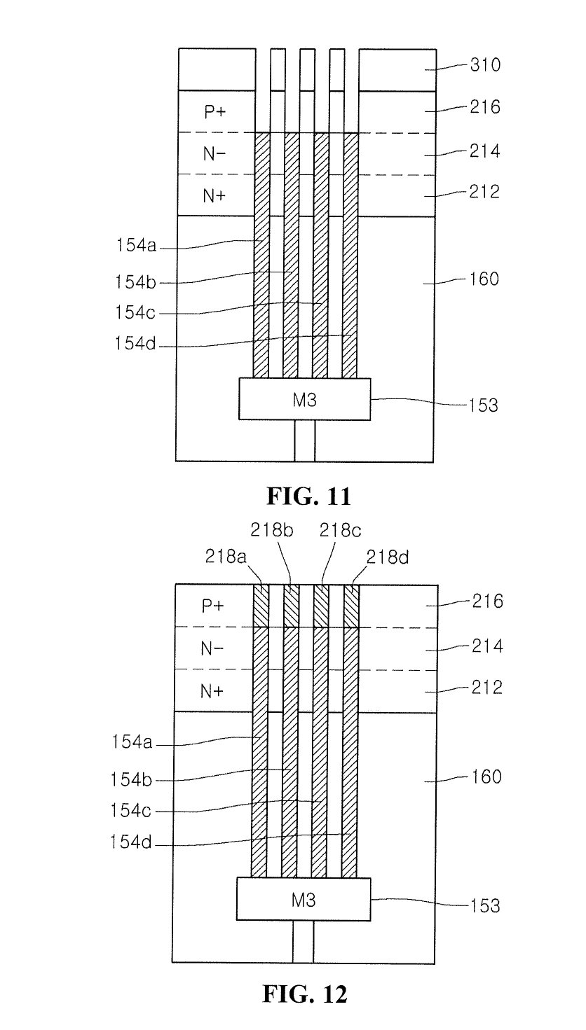

FIG. 10 is a cross-sectional view showing the structure of the image sensor after a second photoresist pattern 310 has been formed, and FIG. 11 is a cross-sectional view showing the structure of the image sensor after an etching process has been performed using the second photoresist pattern 310.

As shown in FIGS. 10 and 11, a second photoresist pattern 310 is formed to expose the first to fourth contact plugs 154a to 154d, and an etching process is performed to remove the upper portion of each of the first to fourth contact plugs 154a to 154d.

At this time, the trenches formed at the upper portions of the contact plugs may have depths corresponding to depths of the second conductive type conduction layer 216. For example, the contact plugs are etched so as to not be in contact with the second conductive type conduction layer 216. Then, the second photoresist pattern 310 is removed.

Referring to FIG. 12, an insulating layer is deposited on the second conductive type conduction layer 216 such that the trenches formed at the upper portions of the first to fourth contact plugs 154a to 154d can be filled with the insulating layer, and then the insulating layer is planarized until the surface of the second conductive type conduction layer 216 is exposed. The insulating layer within the trenches can be referred to as first insulating layer 218a, second insulating layer 218b, third insulating layer 218c, and fourth insulating layer 218d.

For instance, the planarization process may include a CMP (chemical mechanical polishing) process.

Through the above processes, the first to fourth contact plugs 154a to 154d, which connect the first conductive type conduction layer 214 to the third metal 153, can be formed and the first to fourth insulating layers 218a to 218d are formed on the first to fourth contact plugs 154a to 154d in the second conductive type conduction layer 216.

In further embodiments, a top electrode (not shown), a color filter (not shown), and the like can then be formed through subsequent processes to obtain a completed image sensor.

In contrast to a related art, in which the first substrate 100 is bonded to the second substrate 200 to electrically connect the high-concentration first conductive type conduction layer 212 to the third metal 153, an additional contact plug process is performed according to the first embodiment after the substrates have been bonded to each other, so that a defect, which may occur in the bonding process of the substrates, can be inhibited.

In addition, since a plurality of contact plugs can be formed through the photodiode 210, the contact area between the contact plugs (e.g., contact plugs 154a to 154d) and the photodiode 210 can be maximized. Thus, the image sensor can be stably operated even if one of the contact plugs is damaged.

Therefore, the current transfer characteristic between the photodiode 210 (second substrate) and the readout circuitry 120 (first substrate) can be improved, and the operational reliability of the image sensor can be enhanced.

Although four contact plugs 154a to 154d have been described in the first embodiment, the number of the contact plugs may be increased or reduced.

The number of the contact plugs 154a to 154d can be determined by taking the light receiving area of the photodiode 210, and the contact area between the photodiode 210 and the contact plugs 154a to 154d into consideration.

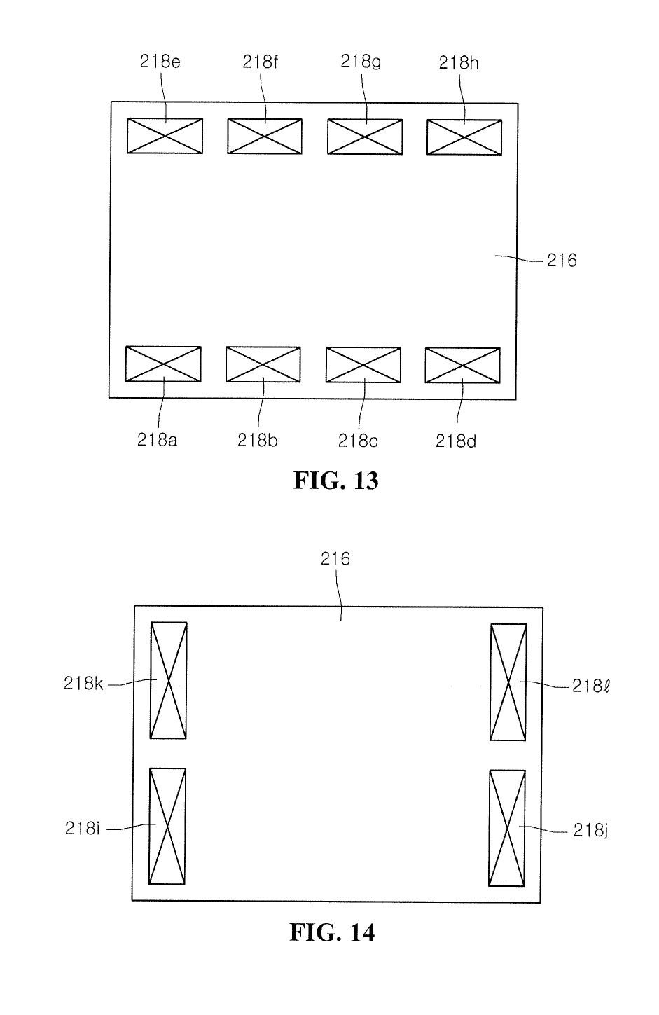

FIG. 13 is a plan view showing the structure of contact plugs with insulating layers 218a, 218b, 218c, 218d, 218e, 218f, 218g, and 218h of the image sensor according to a further embodiment, and FIG. 14 is a plan view showing the structure of contact plugs with insulating layers 218i, 218j, 218k, and 218l of the image sensor according to another embodiment.

According to the description of the first embodiment, the contact plugs and the insulating layers 218a to 218d have the structure of one row and four columns. However, embodiments are not limited thereto. For example, according to the further embodiment shown in FIG. 13, another row of contact plugs can be formed on the uppermost metal 153 such that the contact plugs with the insulating layers 218a to 218h have the structure of two rows and four columns.

In addition, according to another embodiment as shown in FIG. 14, the contact plugs with the insulating layers 218i to 218l have the structure of two rows and two columns.

According to embodiments, the number and the position of the contact plugs and the insulating layers can be adjusted corresponding to the configuration of the photoresist pattern.

Hereinafter, an image sensor according to a second embodiment will be described.

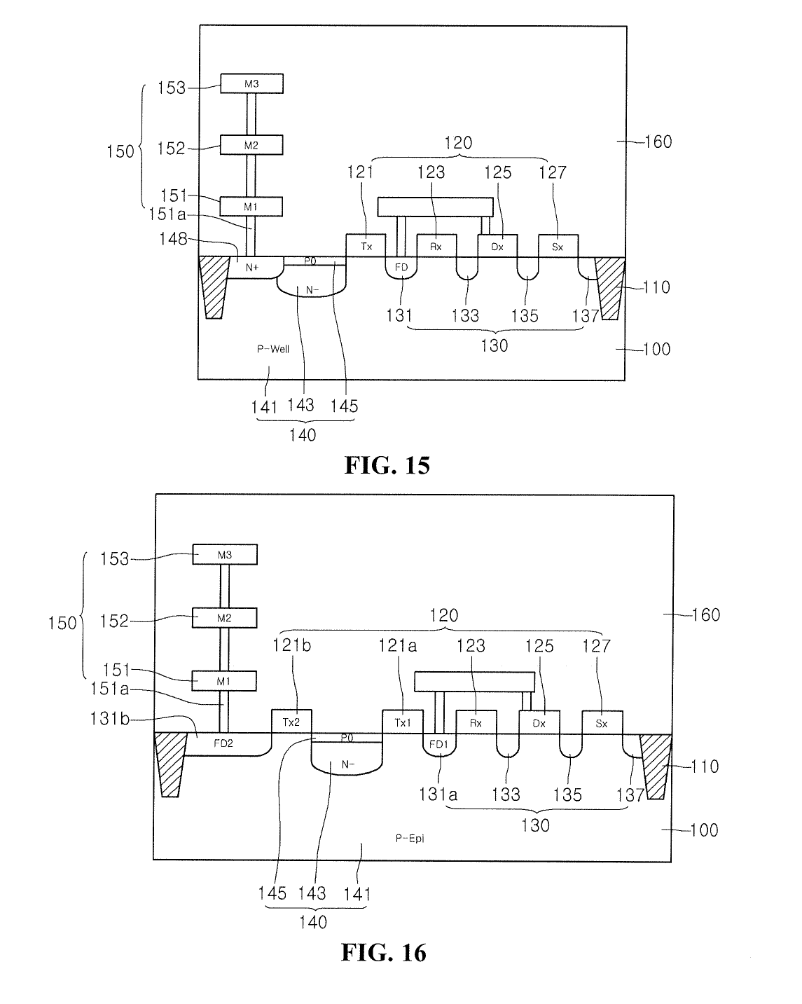

FIG. 15 is a cross-sectional view showing the structure of the image sensor according to a second embodiment.

The image sensor according to the second embodiment includes readout circuitry 120 formed on a first substrate 100, an electric junction area 140 formed on the first substrate 100 while being connected to the readout circuitry 120, an interconnection 150 electrically connected to the electric junction area 140, and an image sensing device (such as reference 210 shown in FIG. 1).

The technical features of the first embodiment can be adopted in the second embodiment.

Hereinafter, the image sensor according to the second embodiment will be described, in which explanation about the elements and structures described in the first embodiment will be omitted in order to avoid redundancy.

Different from the first embodiment, according to the second embodiment, a first conductive type connection region 148 is formed at one side of the electric junction area 140.

According to the first embodiment, the N+ connection region 147 can be formed in the P0/N−/P− junction area 140 for ohmic contact. At this time, the process for forming the N+ connection region 147 and the first metal contact 151a may become a leakage source. That is, since reverse bias voltage is applied to the P0/N−/P− junction area 140 upon operation, an electric field may be generated on the surface of the substrate. A crystal defect generated under the electric field during the process for forming the contact may become the leakage source.

In addition, the electric field is additionally generated by the N+/P0 junction areas 147 and 145 when the N+ connection region 147 is formed on the surface of the P0/N−/P− junction area 140, so the leakage source may be further created.

To address this possible problem, the second embodiment suggests a layout, in which the first contact plug 151a is formed on an active area including the N+ connection region 148 formed without being doped through the P0 layer 145, and the first contact plug 151a is electrically connected to the N− junction area 143 through the N+ connection region 148.

According to the second embodiment, the electric field is not generated on the surface of the silicon substrate, so the dark current can be reduced in the three-dimensional integrated CIS.

The structure and the manufacturing method for the photodiode 210 of the second substrate 200, the contact plugs 154a to 154d, and the insulating layers (218a to 218l) according to the first embodiment and described with respect to FIGS. 7-14 can be adopted in the second embodiment.

FIG. 16 is a cross-sectional view showing the structure of the image sensor according to the third embodiment.

The image sensor according to the third embodiment may include readout circuitry 120 formed on a first substrate 100, an electric junction area 140 formed on the first substrate 100 and electrically connected to the readout circuitry 120, an interconnection 150 electrically connected to the electric junction area 140, and an image sensing device (such as reference 210 shown in FIG. 1) formed on the interconnection 150.

The technical features of the first embodiment can be adopted in the third embodiment.

Hereinafter, the image sensor according to the third embodiment will be described, in which explanation about the elements and structures described in the first and second embodiments will be omitted in order to avoid redundancy.

A method for forming the readout circuitry 120 on the first substrate 100 according to the third embodiment will be described in detail.

In particular, first and second transistors 121a and 121b can be formed on the first substrate 100. For instance, the first and second transistors 121a and 121b may be first and second transfer transistors, respectively, but the embodiment is not limited thereto. The first and second transistors 121a and 121b can be sequentially or simultaneously formed.

Then, an electric junction area 140 is formed between the first and second transistors 121a and 121b. For instance, the electric junction area 140 may include a PN junction, but the embodiment is not limited thereto.

For example, the PN junction 140 of the embodiment may include a first conductive type ion implantation layer 143 formed on a second conductive type well 141 or second conductive type epitaxial layer, and a second conductive type ion implantation area 145 formed on the first conductive type ion implantation area 143.

For example, the PN junction area 140 may include the P0−/N−/P− junction as shown in FIG. 16, but the embodiment is not limited thereto.

A high-concentration first conductive type connection area 131b is formed at one side of the second transistor 121b such that the high-concentration first conductive type connection area 131b can be connected to the interconnection 150. The high-concentration first conductive type connection area 131b is a high-concentration ion implantation area serving as a second floating diffusion area FD2 131b, but the embodiment is not limited thereto.

In this embodiment, the readout circuitry includes a first section to transfer electrons generated from the photodiode on the upper portion of the chip to the N+ junction area 131b of the silicon substrate and a second section to transfer the electrons from the N+ junction area 131b to the N− junction area 140, so that the 4-transistor operation is possible.

As shown in FIG. 16, according to the third embodiment, the P0/N−/P− junction area 140 is separated from the N+ junction area 131b to address the following.

For instance, if the N+ doping and the contact etch are performed on the P/N/P junction of the P0/N−/P− junction area 140, dark current may be generated due to the N+ junction area 131b and contact etch damage. In order to address the above problem, the P0/N−/P− junction area 140 is separated from the N+ junction area 131b.

That is, the N+ doping and the contact etch performed on the surface of the P/N/P junction may become the leakage source. Thus, the contact is formed on the N+ junction area 131b to inhibit the leakage source.

Since the gate of the second transistor 121b can be turned on during the signal readout, the electrons generated from the photodiode 210 on the upper portion of the chip are transferred to the node of the first floating diffusion area 131a through the P0/N−/P− junction area 140, so CDS (correlated double sampling) is possible.

The structure and the manufacturing method for the photodiode 210 of the second substrate 200, the contact plugs 154a to 154d, and the insulating layers (218a to 218l) according to the first embodiment and described with respect to FIGS. 7-14 can be adopted in the third embodiment.

The embodiments may have one or more of the following effects.

First, the contact structure between the photodiode of the donor substrate and the metal structure of the main substrate can be improved, so that the current transfer characteristics can be enhanced.

Second, since the current transfer characteristics can be enhanced between the donor substrate and the main substrate, the operational reliability of the image sensor can be improved and the product yield can be increased.

Third, since the potential difference is generated between the source/drain areas of the transfer transistor Tx, the photo charges can be fully dumped.

Fourth, a charge connection area is formed between the photodiode and the readout circuitry to provide a swift movement path of the photo charges, so that a dark current source can be minimized, and saturation reduction and sensitivity reduction can be minimized or prevented.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An image sensor comprising:
a readout circuitry on a first substrate;
an interlayer dielectric layer including at least one metal and at least one contact plug electrically connected to the readout circuitry;
an image sensing device formed on a second substrate, bonded to the interlayer dielectric layer, and provided with a first conductive type conduction layer and a second conductive type conduction layer; and
a plurality of uppermost contact plugs arranged in a three-dimensional matrix configuration, each uppermost contact plug extending from an uppermost metal of the at least one metal to an inner portion of the first conductive type conduction layer.

2. The image sensor according to claim 1, wherein the uppermost contact plug extends from the uppermost metal to a height below the second conductive type conduction layer through the interlayer dielectric layer and the first conductive type conduction layer, the image sensor further comprising:
an insulating layer formed in the second conductive type conduction layer over each of the uppermost contact plugs.

3. The image sensor according to claim 1, wherein the image sensing device is further provided with a high-concentration first conductive type conduction layer below the first conductive type conduction layer on the interlayer dielectric layer.

4. The image sensor according to claim 1, further comprising an electric junction area formed on the first substrate to electrically connect the readout circuitry to a lowest contact plug of the at least one contact plug.

5. The image sensor according to claim 4, further comprising a first conductive type connection area connected between the electric junction area and the lowest contact plug to electrically connect the lowest contact plug to the electric junction area.

6. The image sensor according to claim 5, wherein the first conductive type connection area is formed at one side of the electric junction area.

7. The image sensor according to claim 4, wherein the electric junction area comprises:
a first conductive type ion implantation area on the first substrate; and
a second conductive type ion implantation area on the first conductive type ion implantation area.

8. The image sensor according to claim 4, wherein the readout circuitry of the first substrate comprises first and second transistors formed on the first substrate, and wherein the electric junction area is formed between the first and second transistors.

9. The image sensor according to claim 8, further comprising a first conductive type second connection area formed at one side of the second transistor, wherein the first conductive type second connection area is connected to the lowest contact plug.

10. A method for forming an image sensor, the method comprising:
forming a readout circuitry on a first substrate;
forming an interlayer dielectric layer including at least one metal and at least one contact plug electrically connected to the readout circuitry;
bonding a second substrate having an image sensing device including a first conductive type conduction layer and a second conductive type conduction layer onto the interlayer dielectric layer such that the first conductive type conduction layer faces the interlayer dielectric layer; and
forming a plurality of uppermost contact plugs extending from an uppermost metal of the at least one metal to an inner portion of the first conductive type conduction layer,
wherein the plurality of uppermost contact plugs is arranged in a three-dimensional matrix configuration.

11. The method according to claim 10, wherein the forming of the readout circuitry comprises forming an electric junction area on the substrate such that a lowest contact plug of the at least one contact plug is electrically connected to the readout circuitry through the electric junction area.

12. The method according to claim 10, wherein the forming of the plurality of uppermost contact plugs comprises:
forming trenches having a three-dimensional matrix configuration in the image sensing device and interlayer dielectric layer, the trenches extending from the second conductive type conduction layer to the uppermost metal;
filling the trenches with a metal layer;
removing an upper portion of metal layer in the trenches, the upper portion contacting the second conductive type conduction layer; and
forming insulating layers by filling insulating materials into portions of the trenches where the upper portion of the metal layer is removed, thereby insulating the second conductive type conduction layer from the uppermost contact plugs.

13. The method according to claim 12, wherein the image sensing device further comprises a high-concentration first conductive type conduction layer, wherein the second substrate is bonded onto the interlayer dielectric layer such that the high-concentration first conductive type conduction layer is below the first conductive type conduction layer,
and wherein the forming of the trenches comprises:
forming a first photoresist pattern having an opening area, which is divided into plural areas in a matrix configuration, on the second conductive type conduction layer in a region corresponding to the uppermost metal;
performing an etching process using the first photoresist pattern as a mask to from a plurality of trenches extending from the second conductive type conduction layer to the uppermost metal through the high-concentration first conductive type layer and the interlayer dielectric layer; and
removing the first photoresist pattern.

14. The method according to claim 12, wherein the removing of the upper portion of the metal layer in the trenches comprises:
forming a second photoresist pattern, which exposes the trenches, on the second conductive type conduction layer;
performing an etching process to remove the upper portion of the metal layer in the trenches; and
removing the second photoresist pattern.

15. The method according to claim 11, wherein the forming of the readout circuitry comprises forming a first conductive type connection area connected to the electric junction area and the lowest contact plug to electrically connect the lowest contact plug to the electric junction.

16. The method according to claim 15, wherein the first conductive type connection area is formed at one side of the electric junction area.

17. The method according to claim 11, wherein the forming of the electric junction area further comprises:
forming a first conductive type ion implantation area on the first substrate; and
forming a second conductive type ion implantation area on the first conductive type ion implantation area.

18. The method according to claim 11, wherein the readout circuitry of the first substrate comprises first and second transistors formed on the first substrate, and wherein the electric junction area is formed between the first and second transistors.

19. The method according to claim 18, further comprising forming a first conductive type second connection area formed at one side of the second transistor and connected to the lowest contact plug.
